(19) United States
(12) Patent Application Publication
(10) Pub. No.: US 2002/0001503 A1
(43) Pub. Date: Jan. 3, 2002

(54) Guide sleeve

(75) Inventor: Kurt Jager, Weinheim (DE)

Correspondence Address: KENYON & KENYON, ONE BROADWAY, NEW YORK, NY, 10004, US

(73) Assignee: Firma Carl Freudenberg

(21) Appl. No.: 09/896,424

(22) Filed: Jun. 29, 2001

(30) Foreign Application Priority Data
Jun. 29, 2000 (DE) 100 31 589.5

(51) Int. Cl. F16D 1/00

(52) U.S. Cl. 403/365; 403/345

(57) ABSTRACT

A guide sleeve includes an outer bushing, which encloses an inner bushing with radial clearance, an elastic spring member made of an elastomeric material being arranged in gap created by the clearance, and inner bushing having at least one lubricant pocket open radially to the inside.

### FIELD OF THE INVENTION

The present invention relates to a guide sleeve.

### BACKGROUND INFORMATION

Conventional guide sleeves are described, for example, in German Published Patent Application No. 196 09 773. This guide sleeve includes an outer bushing made of a hard and ductile material, which surrounds the outside of an elastic spring member made of elastomeric material and is integrally joined thereto. The elastic spring member is designed as a guide ring and has direct adjoining contact with the machine elements to be centered.

### SUMMARY

It is an object of the present invention to provide a guide sleeve in which that abrasive wear is reduced, even when extreme stress is exerted on the guide sleeve.

The above and other beneficial objects of the present invention are achieved by providing a guide sleeve as described herein. In one example embodiment of the present invention, a guide sleeve includes an outer bushing which encloses an inner bushing with radial clearance, an elastic spring member made of elastomeric material being arranged in the gap created by the clearance, and the inner bushing having at least one lubricant pocket open radially to the inside. The inner bushing may be made of a hard and ductile material, for example, a nonferrous metal having improved properties for operation under emergency conditions. During normal use of the guide sleeve, the lubricant pocket is filled with a lubricant, such as, for example, a lubricating grease. The friction between the machine element to be centered and the guide sleeve during relative movement of the parts with respect to another is substantially negligible. Thus, abrasive wear on the surfaces of the inner bushing and the machine element facing one another is substantially prevented during a long service life. The guide sleeve is designed so that swivel motions with small swivel angles, small translatory movements and angular twisting of the machine elements centered with one another may be executed relative to one another.

For example, the lubricant pocket may be formed by a groove that extends in the circumferential direction and is closed upon itself. The contact surfaces of the inner bushing and the machine element to be centered may be well lubricated even if both parts move in a translatory manner relative to one another by only a very small amount in the axial direction. A plurality of grooves extending in the circumferential direction and closed upon themselves may also be provided, which are adjacently assigned to one another with axial clearance.

To provide sufficient lubrication of the surfaces in contact with one another during twisting of the inner bushing relative to the machine element to be centered, the lubricant pocket may, for example, be formed by grooves intersecting in an x-shape. Regardless of the direction of the relative movement with respect to one another of the inner bushing and the machine element to be centered, such a design of the lubricant pocket will substantially always guarantee optimal lubrication with the lowest possible wear on the surfaces coming in contact with one another.

On the side facing radially away from the lubricant pocket, the inner bushing may have a toroidal web or section extending along the peripheral side, the web having at least one perforation extending in the axial direction, which is penetrated by the elastomeric material of the elastic spring member. Such a guide sleeve provides high radial rigidity and simultaneously permits large cardanic excursion movements of the outer bushing and the inner bushing relative to one another. The high radial rigidity is achieved because—observed in longitudinal section—the radial thickness of the elastic spring member in the web area is only relatively low in comparison to the thickness of the elastic spring member in the areas axially adjacent thereto. The large cardanic excursion movements of the inner bushing relative to the outer bushing may be achieved due to the edge areas axially on both sides of the web which—in comparison to the outer circumference of the web—are displaced radially to the inside, and the larger radial clearance to the inner circumference of the outer bushing resulting therefrom. High radial rigidity has the advantage of guaranteeing the centering of the cardan shaft in relation to the gearing and maintaining the imbalance of the drive shaft within the allowed tolerance range.

To ensure uncomplicated and therefore inexpensive producibility of the guide sleeve, at least one perforation may be provided extending in the axial direction through the web. During production of the guide sleeve, the elastomeric material of the elastic spring member flows not only through the small gap in the radial direction between the outer circumference of the web and the inner circumference of the outer bushing, but initially through the perforation, as well. Because of the perforations, the axial flow of the still paste-like material of the elastic spring member is barely impeded in the axial direction, resulting in a sufficient and lasting connection between the outer bushing and the inner bushing.

Improved producibility of the guide sleeve may be achieved by arranging several, e.g., at least three, or e.g., six, perforations evenly spaced in the circumferential direction within the web.

Distribution of the paste-like elastomeric material within the radial gap between the web and the inner circumference of the outer bushing during production of the guide sleeve may be further improved in that the perforations are open radially to the outside, so that in the circumferential direction the web has an essentially toothed-wheel type of design. The perforations are then bounded in the circumferential direction by protuberances extending radially outwardly, the outer bushing also enclosing the protuberances with radial clearance, and the gap created by the clearance being filled with the elastomeric material of the elastic spring member.

In view of easy producibility of the guide sleeve, when viewed in longitudinal section, the inner bushing may include a substantially uniform thickness along its total axial extension. Such a design is advantageous not only for the manufacture of the inner bushing itself but also for the manufacture of the entire guide sleeve. Through the uniform material thickness along the axial extension, the danger of creating casting bubbles—provided that the inner bushing is cast—is reduced to a minimum because of the even cooling of the component after its manufacture. Moreover, a uniform thickness causes uniform thermal conductivity along the entire axial extension, and thus uniform cooling of the elastomeric material of the elastic spring member following its vulcanization. The stress distribution within the elastomeric material after its cooling is then substantially uniform in all partial areas, which guarantees constantly sufficient working properties during a long service life.

The elastic spring member may have a hardness Shore A of, for example, 60±10.

The ratio between the radial thickness of the elastic spring member in the area of the web and the thickness of the elastic spring member in the areas axially adjacent thereto may be, for example, 0.1 to 0.3, in order to permit high radial rigidity and, at the same time, improved cardanic excursion capacity of the inner bushing relative to the outer bushing.

### BRIEF DESCRIPTION OF THE DRAWINGS

FIG. 1 is a schematic cross-sectional view of a longitudinal section of a guide sleeve according to the present invention.

FIG. 2 is a schematic cross-sectional view of the guide sleeve taken along the line A-A illustrated in FIG. 1.

### DETAILED DESCRIPTION

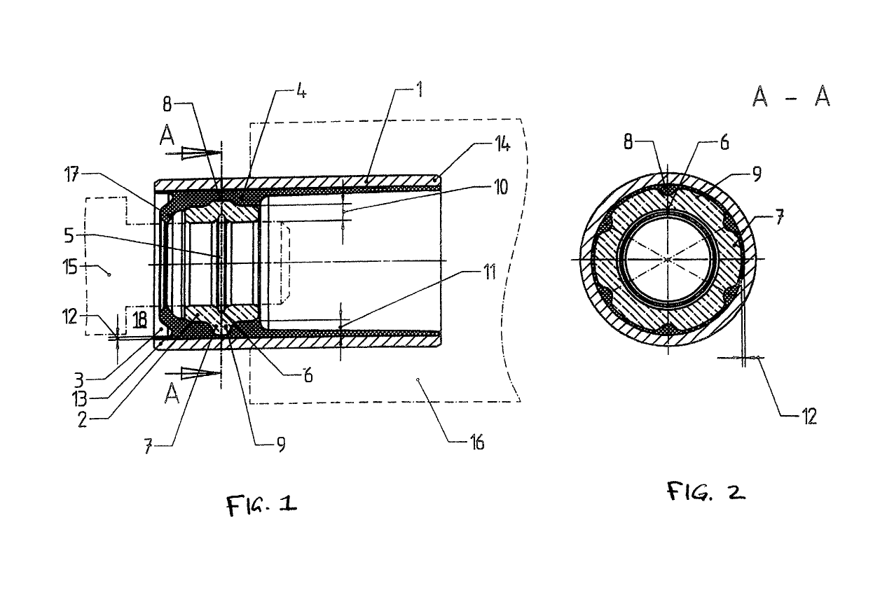

FIGS. 1 and 2 illustrate, in schematic cross-section, an example embodiment of a guide sleeve according to the present invention. The guide sleeve is made of outer bushing 1, which encloses inner bushing 2 with radial clearance. Arranged in gap 3, created by the clearance, is elastic spring member 4 which, in this example embodiment, is made of an elastomeric material with a Shore A 60 hardness.

Outer bushing 1 is made of a metallic material. Generally, however, it is also possible, for example, to make the outer bushing of a hard and ductile polymer material. Inner bushing 2 is made of a sliding-bearing material, such as, for example, an alloy made of copper and zinc or copper and tin.

In this example embodiment of the present invention, lubricant pocket 5 is formed by a groove 6 closed upon itself in the circumferential direction, which is filled with lubricating grease during normal use of the guide sleeve.

The guide sleeve interconnects machine elements 15, 16, which are illustrated by dotted lines. Machine element 15 is enclosed by end face 13 of the guide sleeve, machine element being designed as a shaft end. Machine element 16 encloses outer bushing 1 on the outer periphery. The two machine elements 15, 16 are allocated to one another in a manner allowing relative angular movement. Moreover, machine elements 15, 16 are accommodated by the guide sleeve such that they are movable in the circumferential direction and in a translatory fashion relative to one another.

Second machine element 16 surrounds the guide sleeve in a non-positive manner. First machine element 15 is in adjoining contact with inner bushing 2 on the outer periphery, a sealing lip 17 being adjacently allocated with axial clearance to inner bushing 2 on the side facing surroundings 18. Sealing lip 7 encloses first machine element 15 with radial prestressing, making a seal, and prevents the ingress of impurities into the interior of the guide sleeve.

In this example embodiment of the present invention, toroidal web 7 has six perforations 8 distributed uniformly in the circumferential direction. Perforations 8 are radially open to the outside, as illustrated in the Figures, so that the elastomeric material is distributed on the entire inner circumference of outer bushing 1 during production of the guide sleeve.

The ratio between radial thickness 11 of elastic spring member 4 in the area of web 7 and thickness 12 of elastic spring member 4 in the areas axially adjacent thereto may be, for example, 0.2. Excellent cardanic mobility of the two machine elements 15, 16 relative to one another is thus ensured.

Inner bushing 2 has an substantially uniform thickness 10 along its total axial extension.

As illustrated in FIG. 2, which is a schematic cross-sectional view of the guide sleeve taken along the line A-A illustrated in FIG. 1, the six perforations 8 are evenly distributed in the circumferential direction, production with regard to vulcanization of elastic spring member 4 becoming increasingly easier as the number of perforations 8 increases.

What is claimed is:

1. A guide sleeve, comprising:
an inner bushing;
an outer bushing enclosing the inner bushing with a radial clearance; and
an elastic spring member made of an elastomeric material arranged in a gap created by the radial clearance;
wherein the inner bushing includes at least one lubricating pocket, the at least one lubricating pocket being open radially in an inside direction.

2. The guide sleeve according to claim 1, wherein the at least one lubricating pocket includes a groove extending in a circumferential direction and closing upon itself.

3. The guide sleeve according to claim 1, wherein the inner bushing, on a side facing radially away from the lubricating pocket, includes a toroidal web extending along a periphery, the toroidal web including at least one perforation extending in an axial direction, the at least one perforation being penetrated by the elastomeric material of the elastic spring member.

4. The guide sleeve according to claim 3, wherein the inner bushing includes at least three perforations evenly distributed in a circumferential direction.

5. The guide sleeve according to claim 3, wherein the inner bushing includes six perforations evenly distributed in a circumferential direction.

6. The guide sleeve according to claim 3, wherein the at least one perforation opens radially in an outside direction.

7. The guide sleeve according to claim 3, wherein the at least one perforation is bounded in a circumferential direction by protuberances extending radially to an outside direction, the outer bushing enclosing the protuberances with a radial clearance, the elastomeric material of the elastic spring member being arranged in the gap created by the radial clearance.

8. The guide sleeve according to claim 1, wherein the inner bushing has a substantially uniform longitudinal sectional thickness along an entire axial extension.

9. The guide sleeve according to claim 1, wherein the inner bushing is made of a nonferrous metal.

10. The guide sleeve according to claim 3, wherein a ratio between a radial thickness of the elastic spring member in an area of the toroidal web and a radial thickness of the elastic spring member in areas axially adjacent thereto is approximately 0.1 to 0.3.
